(19) United States
(12) Patent Application Publication
(10) Pub. No.: US 2013/0323473 A1
(43) Pub. Date: Dec. 5, 2013

(54) SECONDARY STRUCTURES FOR AIRCRAFT ENGINES AND PROCESSES THEREFOR

(71) Applicants: Benjamin Allen Dietsch, Dayton, OH (US); James Michael Kostka, Mason, OH (US); David Edward Dale, Cincinnati, OH (US); Jared Matthew Wolfe, Monroe, OH (US)

(72) Inventors: Benjamin Allen Dietsch, Dayton, OH (US); James Michael Kostka, Mason, OH (US); David Edward Dale, Cincinnati, OH (US); Jared Matthew Wolfe, Monroe, OH (US)

(73) Assignee: GENERAL ELECTRIC COMPANY, Schenectady, NY (US)

(21) Appl. No.: 13/483,196

(22) Filed: May 30, 2012

(51) Int. Cl. B32B 1/00; B05D 7/00; B05D 1/36; C08L 61/00; B23P 11/00; C08L 81/06; C08L 81/04; C08L 77/06; C08L 77/00; B29C 35/08; C08L 79/08

(52) U.S. Cl. 428/174; 264/497; 427/407.1; 427/404; 524/592; 524/606; 524/609; 29/888.012

(57) ABSTRACT

Processes for fabricating secondary structures of gas turbine engines from polymer-based materials, and secondary structures formed thereby. The processes entail performing an additive manufacturing technique to produce a secondary structure of a gas turbine engine. The additive manufacturing technique directly produces the secondary structure from a polymer-based material to have a complex three-dimensional shape characterized by portions that lie in different planes.

### BACKGROUND OF THE INVENTION

The present invention generally relates to secondary structures of aircraft engines, as an example, brackets used in aircraft engines, and to processes for their production. More particularly, this invention is directed to methods of fabricating secondary structures from polymer-based materials, including reinforced (composite) polymer-based materials and non-reinforced polymer-based materials, using additive manufacturing (AM) techniques.

The maturation of polymer technologies has increased the opportunities for the use of polymer-based non-reinforced (neat) and composite materials in a wide variety of applications, including but not limited to aircraft engines such as the GE90® and GEnx® commercial engines manufactured by the General Electric Company. Historically, the fabrication of components from polymer-based materials has been driven by the desire to reduce weight, though increases in metal costs have also become a driving factor for some applications.

Composite materials generally comprise a fibrous reinforcement material embedded in a matrix material, which in the case of a polymer composite material is a polymer material (polymer matrix composite, or PMC). In contrast, non-reinforced polymer materials lack any such reinforcement material. The reinforcement material of a PMC material serves as the secondary constituent of the composite material, while the matrix material protects the reinforcement material, maintains the orientation of its fibers and serves to dissipate loads to the reinforcement material. Resins for matrix materials of PMCs can be generally classified as thermosets or thermoplastics. Thermoplastic resins are generally categorized as polymers that can be repeatedly softened and flowed when heated, and hardened when sufficiently cooled due to a physical rather than chemical change. Notable example classes of thermoplastic resins include nylons, thermoplastic polyesters, polyaryletherketones, and polycarbonate resins. Specific examples of high performance thermoplastic resins that have been contemplated for use in aerospace applications include polyetheretherketone (PEEK), polyetherketoneketone (PEKK), polyetherimide (PEI) and polyphenylene sulfide (PPS). In contrast, once fully cured into a hard rigid solid, thermoset resins do not undergo significant softening when heated, but instead thermally decompose when sufficiently heated. Notable examples of thermoset resins include epoxy and polyester resins. A variety of fibrous reinforcement materials have been used in PMCs, for example, carbon (e.g., AS4), glass (e.g., S2), polymer (e.g., Kevlar®), ceramic (e.g., Nextel®) and metal fibers. Fibrous reinforcement materials can be used in the form of relatively short chopped fibers or long continuous fibers, the latter of which are often used to produce a “dry” fabric or mat. PMC materials can be produced by dispersing short fibers in a matrix material, or impregnating one or more fiber layers (plies) of dry fabrics with a matrix material.

Whether a polymer-based material (which, as used herein, refers to both non-reinforced polymer materials and PMC materials) is suitable for a given application depends on the mechanical, chemical and thermal requirements of the particular application, and in the case of PMC materials, the particular matrix and reinforcement materials and the feasibility of fabricating a PMC article having the required geometry. Due to their considerable potential for weight savings, various applications have been explored for non-reinforced polymer materials and particularly PMC materials in aircraft gas turbine engines. However, a challenge has been the identification of material systems that have acceptable properties yet can be produced by manufacturing methods to yield a cost-effective component. For example, it is well known that aircraft engine applications have high performance mechanical requirements, for example, strength and fatigue properties (necessitated by vibrations in the engine environment), as well as high temperature properties, chemical/fluid resistance, etc. As particular examples, brackets and other secondary components located exteriorly of the core engine (module) of a high-bypass turbofan engine, for example, within the nacelle or surrounding the fan section of such an engine, are not directly subjected to the hostile thermal environment within the core engine, yet are subjected to vibration, elevated temperatures, chemicals, etc., that impose demanding performance requirements. Consequently, though considerable weight savings could be realized by fabricating brackets and other secondary components of aircraft engines from polymer-based materials, such performance requirements, as well as the size, variability and complexity of such brackets, have complicated the ability to cost-effectively produce brackets from these materials. For example, the use of traditional thermoset resins to produce PMC brackets has been generally viewed as cost prohibitive due to the labor-intensive process and long manufacturing cycle times involved with thermosets, as well as the large number of relatively small brackets having many different part configurations. On the other hand, PMCs formed with thermoplastic matrix materials are limited by their tendency to soften and lose strength at elevated temperatures.

Another complication is the type of reinforcement system required by PMC materials in aircraft engine applications. Generally, to realize a significant level of weight savings through the use of thermoset or thermoplastic PMC materials, brackets would require the use of continuous fiber-reinforced PMC materials to enable their cross-sections to be minimized while simultaneously achieving the high performance mechanical requirements (particularly strength and fatigue properties) dictated by aircraft engine applications. However, hand lay-up processes involved in the use of continuous fiber reinforcement materials further complicate the ability to produce a wide variety of relatively small brackets having complex shapes. On the other hand, chopped fiber reinforcement systems, whether in a thermoplastic or thermoset resin matrix, are not an ideal solution due to their lower mechanical performance. In particular, the lower strength of PMC components reinforced with chopped fibers necessitates the fabrication of a relatively thick and heavy bracket. Furthermore, chopped fiber systems are often processed using net shape molding methods, which enable complex shapes to be formed. However, because there are a large number of brackets that have different shapes on aircraft engines, the tooling cost associated with an individual mold being required for each unique bracket generally prohibits this manufacturing approach.

### BRIEF DESCRIPTION OF THE INVENTION

The present invention provides for the fabrication of secondary structures of gas turbine engines from polymer-based materials, and secondary structures formed thereby. Notable but nonlimiting examples of secondary structures include various types of brackets that are located outside the core engine but within the nacelle or surrounding the fan section of a high-bypass gas turbine engine. Other examples include shrouds, lids, covers, cover plates, vent covers, etc.

According to a first aspect of the invention, a process is provided that entails performing an additive manufacturing technique to produce a secondary structure of a gas turbine engine. The additive manufacturing technique directly produces the secondary structure from a polymer-based material to have a complex three-dimensional shape characterized by portions that lie in different planes.

A second aspect of the invention includes secondary structures produced by the processing steps described above and subsequently installed on a gas turbine engine.

Additional aspects of the invention include a secondary structure of an aircraft engine, wherein the secondary structure is formed of a polymer-based material so as to be monolithically formed, and has a complex three-dimensional shape characterized by a unitary construction that comprises portions that have varying thicknesses and that lie in different planes.

A technical effect of this invention is the ability to produce and utilize secondary structures in aircraft engines, which greatly benefit from weight savings but simultaneously impose demanding mechanical and environmental performance requirements on secondary structures. The invention enables the fabrication of secondary structures from polymer-based materials in a manner that minimizes manufacturing and materials costs and/or weight without compromising the functionality of the secondary structure. More particularly, a secondary structure of this invention is monolithically formed from a polymer-based material using an additive manufacturing technique to have a unitary construction, in other words, the secondary structure is not an assembly comprising discrete and separately formed subcomponents. Even so, secondary structures of this invention are capable of having complex geometries. Furthermore, complex geometries can be achieved without the tooling costs usually associated with such conventional processing methods as net shape molding methods.

Other aspects and advantages of this invention will be better appreciated from the following detailed description.

### BRIEF DESCRIPTION OF THE DRAWINGS

FIG. 1 schematically represents a perspective view of a bracket formed by assembling metal subcomponents in accordance with the prior art.

FIG. 2 schematically represents a perspective view of a bracket suitable as a replacement for the bracket of FIG. 1, but formed by an additive manufacturing technique in accordance with an embodiment of the present invention.

### DETAILED DESCRIPTION OF THE INVENTION

The present invention will be described in terms of fabricating secondary structures that, though capable of being adapted for use in a wide range of applications, are particularly well suited as brackets whose primary purpose is to support or secure various components of aircraft engines, for example, components outside the core engine of a high-bypass gas turbine engine, but within the nacelle or surrounding the fan section of such an engine. Particularly notable examples of secondary structures include brackets that are mounted on the exterior of the fan case that support other parts such as tubes, hoses, manifolds, wiring harnesses, and other components such as the oil tank, FADEC (full authority digital electronic control), etc. However, various other secondary structures and various other applications to which the present invention could be applied are also within the scope of the invention.

The present invention provides processes by which secondary structures capable of being produced in a cost-effective manner, yet are able to exhibit mechanical, chemical and thermal properties (including strength, fatigue resistance, maximum temperature capability, chemical/fluid resistance, etc.) that are suitable for aircraft engine applications. More particularly, the invention involves producing secondary structures that are fabricated from polymer-based materials (non-reinforced polymers and/or PMC materials) using an additive manufacturing (AM) technique capable of directly yielding secondary structures having relatively complex three-dimensional shapes characterized by portions that lie in different planes, as opposed to simple shapes characterized by a single flat panel having a substantially constant cross-sectional thickness.

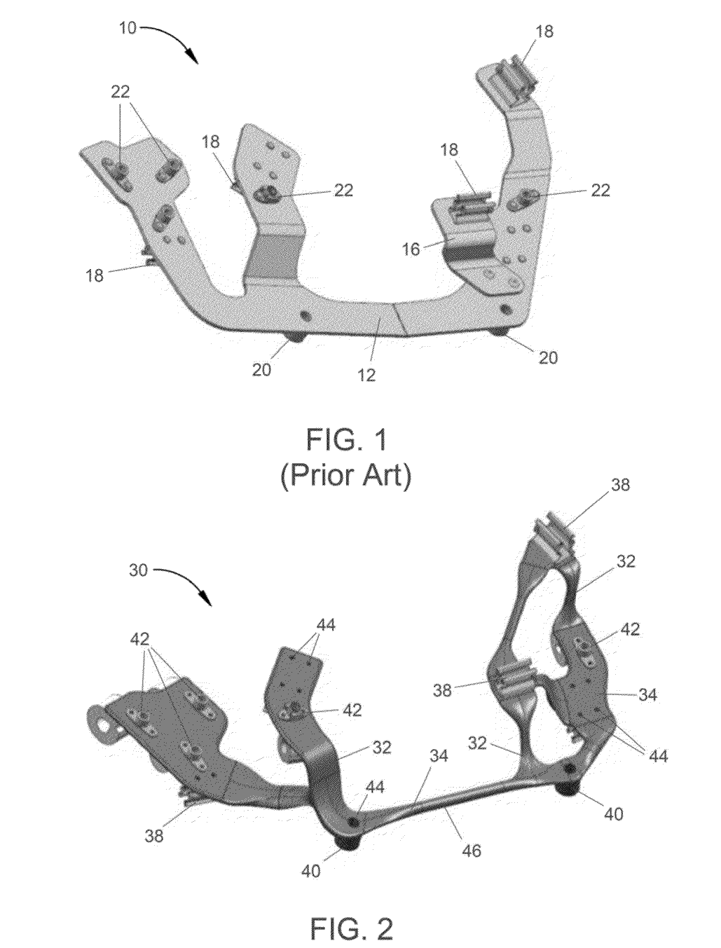

FIG. 1 depicts a bracket assembly 10 as a representative but nonlimiting example of a secondary structure having a complex three-dimensional shape. The bracket assembly 10 has a metal construction in accordance with conventional practice. Furthermore, the bracket assembly 10 can be seen to have a complex three-dimensional shape that, because of its metal construction, necessitates that the bracket assembly 10 be assembled from multiple separately fabricated subcomponents 12 and 16, for example, individual stampings. Finally, the bracket assembly 10 is shown to include spring clips 18, spacers 20 and nut plates 22 that facilitate the installation of the bracket assembly 10 on an aircraft engine or facilitate the attachment to the assembly 10 of tubes, wiring harnesses, hoses, manifolds, and other components such as the oil tank, FADEC, etc., intended to be mounted to the engine.

FIG. 2 depicts a bracket 30 as another representative but nonlimiting example of a secondary structure having a complex three-dimensional shape. In contrast to the bracket assembly 10 of FIG. 1, the bracket 30 shown in FIG. 2 has a polymer-based material construction in accordance with a preferred aspect of the invention. Furthermore, the bracket 30 is fabricated using an additive manufacturing process that enables the bracket 30 to be monolithically formed to have a unitary construction, the only exceptions being spring clips 38, spacers 40 and nut plates 42 similar to the metal bracket assembly 10 of FIG. 1. Notably, the locations of its spring clips 38, spacers 40 and nut plates 42 enable the bracket 30 of FIG. 2 to entirely replace the bracket assembly 10 of FIG. 1. The use of an additive manufacturing process to produce the bracket 30 avoids the difficulties and costs of assembling the bracket 30, and permits the bracket 30 to have a complex unitary shape in which the cross-sectional thicknesses of the bracket 30 can vary considerably.

Preferred polymer-based materials for use with this invention are thermoplastics, particularly notable examples of which include polyetheretherketone (PEEK), polyetherketoneketone (PEKK), polyetherketoneetherketoneketone (PEKEKK), polyetherimide (PEI), polyphenylene sulfide (PPS), polysulfone (PSU), polyamide (PA), and polyphthalamide (PPA). These materials are particularly suitable for use as the thermoplastic matrix material of a PMC reinforced with an embedded reinforcement material. Preferred reinforcement materials for use in the invention are discontinuous materials, for example, chopped fiber, microballoons, and nano-reinforcement materials. Particularly suitable chopped fiber materials include carbon (e.g., AS4), glass (e.g., S2), polymer (e.g., aramid, such as Kevlar®), ceramic and metal fibers. Particularly suitable lengths for the fibers are typically 10 mm or less. Other suitable discontinuous reinforcement materials are believed to include nanofibers, multi- and single wall carbon nanotubes, graphene and/or clay nanoplatelets. These reinforcement materials may be coated with functional coatings, nonlimiting examples of which include nickel and silver. Additional materials capable of acting as reinforcement material include glass, polymer, carbon, or ceramic microballoons or microspheres, which may also have functional coatings, such as nickel or silver, on them. However, it is foreseeable that other suitable polymer materials, which may be suitable as the matrix and/or reinforcement materials of a PMC, could be used or later developed for use with the present invention. Other suitable reinforcement materials could be used, or later developed for use with the present invention as well. Suitable fiber contents for the PMC materials of this invention can vary widely, though it is believed that the fiber content should not be more than 50 percent by volume, and preferably not more than about 30 percent by volume, with a preferred range believed to be about 0.1 to about 30 percent by volume.

Additive manufacturing techniques that are particularly suitable for use in the invention generally include methods by which a polymeric material is melted or softened to build up a three-dimensional structure in a series of sequentially formed layers. To enable the fabrication of a bracket 30 (or other secondary structure) that incorporates one or more discontinuous reinforcement materials as discussed above, preferred additive manufacturing techniques are also capable of utilizing a polymeric material that contains the desired reinforcement material. Two particular examples are selective laser sintering (SLS) and fused deposition modeling (FDM). SLS techniques generally involve selectively sintering (fusing) a mass of granular or powder material of the desired polymer-based material to form a solid sintered three-dimensional structure. The material is sintered as a result of selected portions of the mass being heated by a laser beam or other directed energy source that is moved in transverse directions (for example, horizontal directions) over the mass relative to the direction of the laser beam, as well as parallel to the path of the beam (for example, in the vertical direction) as the sintering process progresses. Movement of the laser beam can be numerically controlled, for example, as a result of being directly controlled by computer-aided manufacturing (CAM) software. During the sintering process, sintered and unsintered regions of the powder material serve to support subsequently sintered material to allow for the fabrication of sintered structures having transverse projections (relative to the direction that the sintering process progresses through the material). Optimal operating parameters for a laser used in an SLS process and optimal processing parameters for the SLS process as a whole will depend on the particular materials being sintered and the extent to which the structure is desired to be fully dense and void-free. To incorporate a discontinuous reinforcement material, the polymer-based particles of the powder can be produced to contain the reinforcement material, or the particles can be mixed or blended with the reinforcement material.

FDM techniques involve dispensing a filament of the desired polymer-based material by extruding the material through a heated nozzle at a sufficient temperature to cause the material to at least partially melt as the nozzle is moved in transverse directions (for example, horizontal directions) relative to the direction in which the material is deposited, as well as parallel to the extrusion direction (for example, in the vertical direction) as the process progresses. As with the laser used in an SLS process, the movement of the nozzle can be numerically controlled, for example, using CAM software. A three-dimensional structure is built up as a result of the extruded material being deposited and fused to form sequential layers of the desired polymer or composite material. As with the SLS process, the polymer-based material can be produced to contain a discontinuous reinforcement material, or a discontinuous reinforcement material may be co-extruded with the polymer-based material so that the polymer-based material and reinforcement material are simultaneously deposited.

Because a resulting monolithic article (such as the bracket 30) produced in accordance with the above contains a discontinuous reinforcement material, as opposed to a continuous fiber reinforcement material, the shape and dimensions of the monolithic article should take into consideration certain aspects of its intended application, including load levels and fatigue. Based on the foregoing, it can be appreciated that the thickness of a secondary structure formed by an additive manufacturing process can vary considerably, depending on its intended use and the loads and fatigue conditions to which the structure will be subjected. As an example, the bracket 30 of FIG. 2 includes several L-shaped portions 32 (L-shaped cross-sections) projecting from relatively planar regions 34 of the bracket 30. As evident from FIG. 2, the portions 32 all lie in different planes relative to each other and to the base regions 34. FIG. 2 also represents the bracket 30 as formed to include holes 44 by which the spring clips 38 and nut plates 42 can be attached to the bracket 30, enabling the bracket 30 to be mounted on the exterior of a gas turbine engine, for example, its fan case, and/or to attach or support engine components such as tubes, hoses, manifolds, wiring harnesses, and other components such as the oil tank, FADEC, etc., intended to be mounted to the engine. While L-shaped portions 32 are shown in FIG. 2, other shapes can be produced by additive manufacturing, including but not limited to C-shaped features (having a C-shaped cross-section) or variants thereof, for example, shapes having U- or V-shaped cross-sections. The holes 44 can also be produced by the additive manufacturing process, though it is also foreseeable that the holes 44 could be formed by machining the bracket 30 after it has been fabricated by the additive manufacturing process. The holes 44 (or slots or other features) can be adapted to accommodate conventional mechanical fasteners and/or attachment mechanisms, for example, nut plates and spring clips that can be mounted to the bracket 30.

While the bracket 30 of FIG. 2 is representative of a type of three-dimensional structure that can be produced in accordance with this invention, it should also be noted that less complicated and more complicated cross-sectional shapes are also possible. A secondary structure is considered herein to have a complex shape if it has a monolithically-formed unitary construction that cannot be formed by simply fastening, joining or bending a flat panel having a substantially constant cross-sectional thickness.

FIG. 2 schematically represents the bracket 30 as further incorporating an insert 46 that is embedded in the polymer-based material that forms one of the base regions 34 of the bracket 30. The insert 46 is represented as a reinforcement insert 46 that serves to structurally stiffen the bracket 30 or promote its strength along one or more load paths of the bracket 30. In particular, the insert 46 can serve to stiffen the bracket 30, take the application loads, and form that portion of the bracket 30 that is directly mounted to the engine. Portions and regions of the bracket 30 that do not contain an insert allow for more complex geometries to be achieved, while preferably having a lower loading requirement. The insert 46 can be directly incorporated into the bracket 30 during its fabrication by additive manufacturing, for example, as a result of being appropriately pre-placed in a mass of powder material that undergoes SLS, or appropriately placed on a polymer layer deposited by FDM. Additional or other structural features can also be incorporated into the bracket 30 during its fabrication. Furthermore, it should be understood that insert 46 incorporated into the bracket 30 is not limited to polymer-based materials, but instead could be formed of metallic-based or ceramic-based materials. In some applications, a more preferred material for the insert 46 is a PMC material, which may contain a continuous fiber reinforcement material and utilize the very same matrix material as the polymeric material utilized for the remainder of the bracket 30.

Another aspect of the invention is the ability to form the polymer-based material of the bracket 30 around certain inserts, for example, metallic fasteners such as bushings, threaded inserts, spring clips, nut plates, etc., including any one or more of the spring clips 38, spacers 40 and nut plates 42 shown in FIG. 2. Metallic inserts of these types help to alleviate crush stress, torque retention, and stress relaxation issues that tend to exist with polymeric materials. By forming the bracket 30 (or other secondary structure) around inserts during the additive manufacturing process has the ability to avoid the need for any subsequent process, such as machining (e.g., drilling holes) or assembling multiple components together. It is also within the scope of the invention that inserts of this type could be directly fabricated during the additive manufacturing process from the polymer-based material used to form the bracket 30 or other secondary structure.

Finally, the bracket 30 can be provided with a metallic coating on one or more of its surfaces to promote certain properties, for example, the thermal conductivity, electrical conductivity, chemical resistance, and/or wear resistance of its surfaces. Such a coating may also stiffen the system and enhance the mechanical properties. A particular but nonlimiting example is a nanocrystalline plating deposited by an electroplating technique. A suitable thickness for such a coating is generally on the order of about 10 to about 250 micrometers, and suitable materials for such a coating include but are not limited to nickel, aluminum, copper, silver, chromium, and alloys and combinations thereof.

While the invention has been described in reference to a specific embodiment, it is apparent that other forms could be adopted by one skilled in the art. Therefore, the scope of the invention is to be limited only by the following claims.

1. A process comprising:
performing an additive manufacturing technique to produce a secondary structure of a gas turbine engine, the additive manufacturing technique directly producing the secondary structure from a polymer-based material to have a complex three-dimensional shape characterized by portions that lie in different planes.

2. The process according to claim 1, wherein the polymer-based material is a non-reinforced thermoplastic or a polymer matrix composite material comprising a thermoplastic reinforced with a discontinuous reinforcement material.

3. The process according to claim 2, wherein the thermoplastic is chosen from the group consisting of polyetheretherketone, polyetherketoneketone, polyetherketoneetherketoneketone, polyetherimide, polyphenylene sulfide, polysulfone, polyamide, and polyphthalamide.

4. The process according to claim 2, wherein the polymer-based material is the polymer matrix composite material and the discontinuous reinforcement material is chosen from the group consisting of chopped fiber, microballoons, and nano-reinforcement materials.

5. The process according to claim 1, further comprising installing the secondary structure on the gas turbine engine.

6. The process according to claim 1, wherein the additive manufacturing step results in at least one insert being at least partially embedded in the polymer-based material of the secondary structure.

7. The process according to claim 6, wherein the insert is a spring clip, spacer, nut plate, fastener or bushing adapted to interface with the gas turbine engine or a component of the gas turbine engine.

8. The process according to claim 6, wherein the insert is a reinforcement insert adapted to structurally stiffen the secondary structure along one or more load paths thereof.

9. The process according to claim 8, wherein the insert is formed of a polymer matrix composite material with continuous fiber reinforcement.

10. The process according to claim 9, wherein the continuous fiber reinforcement of the insert is embedded in a matrix formed of the polymer-based material of the secondary structure.

11. The process according to claim 6, wherein the insert is formed of a metallic-based or ceramic-based material.

12. The process according to claim 1, wherein the additive manufacturing step comprises subjecting a mass of a thermoplastic powder material to a laser beam to selectively sinter limited portions of the mass to form the secondary structure.

13. The process according to claim 1, wherein the additive manufacturing step comprises heating a thermoplastic material and depositing layers of the thermoplastic material to build up the secondary structure.

14. The process according to claim 1, further comprising a metallic coating on an exterior surface of the secondary structure, the metallic coating having a thickness of about 10 to about 250 micrometers and being formed of a material chosen from the group consisting of nickel, aluminum, copper, silver, chromium, and alloys and combinations thereof.

15. The secondary structure produced by the process of claim 1.

16. The process according to claim 1, wherein the secondary structure is an aircraft engine bracket.

17. The aircraft engine bracket produced by the process of claim 16.

18. A secondary structure of an aircraft engine, the secondary structure being formed of a polymer-based material and having a complex three-dimensional shape characterized by portions that lie in different planes, the secondary structure being fabricated by an additive manufacturing technique that results in the secondary structure comprising a series of sequentially formed layers of the polymer-based material.

19. The secondary structure according to claim 18, wherein the polymer-based material is a non-reinforced thermoplastic or a polymer matrix composite material comprising a thermoplastic reinforced with a discontinuous reinforcement material.

20. The secondary structure according to claim 19, wherein the thermoplastic is chosen from the group consisting of polyetheretherketone, polyetherketoneketone, polyetherketoneetherketoneketone, polyetherimide, polyphenylene sulfide, polysulfone, polyamide, and polyphthalamide.

21. The secondary structure according to claim 19, wherein the polymer-based material is the polymer matrix composite material and the discontinuous reinforcement material is chosen from the group consisting of chopped fiber, microballoons, and nano-reinforcement materials.

22. The secondary structure according to claim 18, further comprising at least one insert at least partially embedded in the polymer-based material of the secondary structure.

23. The secondary structure according to claim 22, wherein the insert is a spring clip, spacer, nut plate, fastener or bushing adapted to interface with the gas turbine engine or an engine component of the gas turbine engine.

24. The secondary structure according to claim 22, wherein the insert is a reinforcement insert adapted to structurally stiffen the secondary structure along one or more load paths thereof.

25. The secondary structure according to claim 24, wherein the insert is formed of a polymer matrix composite material with continuous fiber reinforcement.

26. The secondary structure according to claim 24, wherein the continuous fiber reinforcement of the insert is embedded in a matrix formed of the polymer-based material of the secondary structure.

27. The secondary structure according to claim 22, wherein the insert is formed of a metallic-based or ceramic-based material.

28. The secondary structure according to claim 18, further comprising a metallic coating on an exterior surface of the secondary structure, the metallic coating having a thickness of about 10 to about 250 micrometers and being formed of a material chosen from the group consisting of nickel, aluminum, copper, silver, chromium, and alloys and combinations thereof.

29. The secondary structure according to claim 18, wherein the secondary structure is an aircraft engine bracket that is mounted on an exterior of a fan casing of an aircraft engine and secures a component to the fan casing.
